(19) United States
(12) Patent Application Publication
(10) Pub. No.: US 2003/0061405 A1
(43) Pub. Date: Mar. 27, 2003

(54) System, method and computer program product for protocol-independent processing of information in an enterprise integration application

(75) Inventors: Randall Fisher, Lutz, FL (US); Shawn R. Potts, Tampa, FL (US); Mark J. Sexton, Tampa, FL (US)

Correspondence Address: Andrew C. Greenberg, Esq., Carlton Fields, P.A., P.O. Box 3239, Tampa, FL, 33601-3239, US

(73) Assignee: Open Technologies Group, Inc.

(21) Appl. No.: 09/930,075

(22) Filed: Aug. 15, 2001

(51) Int. Cl. G06F 1/12; G06F 9/46

(52) U.S. Cl. 709/400; 709/313

(57) ABSTRACT

A system, method and computer program product for protocol-independent processing of information in an enterprise integration application. The system includes host processors for managing flow of information throughout the system, channel processors for operatively communicating between processors in the system, and preexisting legacy processors. The system dynamically maintains uniform configuration of its topology and the means by which it routes information across the system in accordance with predefined business rules. In operation, processors interact with corresponding channel processors to intercommunicate legacy systems and the enterprise integration application system. Messages are received at host processors from communicating channel processors and routed in accordance with message key information to appropriate destination host processors and terminating applications in order to achieve an intercommunication between the legacy systems in accordance with communications requirements and a predefined set of business logic rules. Communications among the enterprise application system and the legacy systems with which it operates are not limited by network or communication protocols, network or communications media or particular representations of their data.

### FIELD OF THE INVENTION

This invention relates to processing information in an enterprise integration application, and more particularly, relates to a protocol-independent framework for agile design, organization, operation and maintenance of the enterprise integration application.

### BACKGROUND OF THE INVENTION

Individuals and enterprises have become increasingly dependent upon a rapidly expanding variety of available computer systems, networks, software applications, platforms, operating systems, the internet, communications devices—including wireless devices, automated processes, and the like. These systems may be newly constructed and readily interoperable in accordance with various well-known standards, or “black-box” legacy systems embodying unspecified but critical business logic. Demand has steadily increased among individuals and enterprises to quickly and inexpensively achieve interoperability among all such systems and devices, and to exploit the embedded business logic, and develop therefrom comprehensive solutions leveraging capabilities of the underlying components.

A need has therefore arisen for an enterprise integration application that provides enterprise-wide hardware and protocol independent interfacing between disparate systems or devices. As industry develops new and better protocols and standards for devices, operating systems, languages, and data structures, consumers are frustrated with incompatibility of new products and existing products. This frustration is further exacerbated by the inability of the industry to settle on basic data structure standards, as various companies and organizations insist that their proprietary structures become “the” standard.

Consumers of prior art systems and devices presently dedicate substantial resources to create the necessary interfaces for interoperation. Although products exist to solve certain related problems for particular devices and protocols, the prior art lacks an agile, scalable and maintainable enterprise integration application framework that permits interfacing arbitrary protocols and standards, including those not yet developed, with arbitrary software systems, including those not yet developed. Somewhat in the sense that TCP/IP and related networking standards facilitated a form of internetworking among a wide range of devices at various levels without regard to underlying hardware, the present invention provides a framework for interapplication among a wide range of information systems and communication devices without regard to underlying communication protocols and underlying application interfaces.

By providing an overarching framework to process information across an enterprise integration application using arbitrary messaging protocols across an arbitrary set of communication devices using arbitrary communication protocols, a general-purpose tool is disclosed to design, implement, operate and manage an interapplication facility among enterprise integration applications and legacy systems and communication devices much in the way that TCP/IP and related standards provided a framework to facilitate the design, operation and management of an internet.

Some, but not all, traits of a robust EAI solution are provided in the prior art. An Informational Receipt EAI solution provides a protocol that enables components/systems to accept data and interpret that data as information. An Information Request EAI solution enables components/systems to send a request for data in such a manner that the provider of such data understands the request and returns the data, which the requester can interpret as information.

A Component Processing Receipts EAI solution provides a protocol that enables components/systems to accept data and interpret that data for execution by the component. A Component Processing Requests EAI solution provides a protocol that enables components/systems to send a request for execution in such a manner that the receiver understands and executes the request. A Component Processing Flow EAI solution provides a protocol that enables components/systems to process a series of processes for execution in a series of steps. A Dynamic Component Processing Flow EAI solution provides a protocol that enables components/systems to process a series of processes for execution (“execution steps”) in such a manner that the results of each step can alter the nature of the next execution step which is taken.

A Business Processing Receipts EAI solution provides a protocol that enables components/systems to accept data and interpret the data as a defined series of processes for execution that reflects business logic. A Business Processing Request EAI solution provides a protocol that enables components/systems to send a request for a defined series of processes for execution that reflects business logic in such manner that the receiver can comprehend the request and execute the processes. A Business Processing Request Flow EAI solution provides a protocol that enables components/systems to process a series of business logic processes for execution in a series of steps. A Dynamic Business Processing Flow EAI solution provides a protocol that enables components/systems to process a series of business logic processes for execution in a series of steps, and in such a manner that the results of each business logic execution step can alter the nature of the next business logic execution step which is taken.

A Configurable EAI solution provides a Protocol that allows the ability to be designed, arranged, set up or shaped to be used for specific instances of needed use. A Feasibly Configurable EAI solution provides a protocol that allows the ability to be designed, arranged, set up or shaped to be used for specific instances of needed use in such a manner that is cost and time effective. A Dynamically Configurable EAI solution provides a protocol that allows the ability to be designed, arranged, set up or shaped to be used for specific instances of needed use in such a manner that requires no direct human intervention at time of configuration change. A Feasibly Dynamically Configurable EAI solution provides a protocol that allows the ability to be designed, arranged, set up or shaped to be used for specific instances of needed use in such a manner that requires no direct human intervention at time of configuration change and whose supporting information is created and available in a manner that is cost and time effective.

The prior art includes foundational exchange protocols that permit communication between a wide, but limited, range of disparate systems and equipment, such as TCP/IP, COM, DCOM, CORBA, MSMQ, IBM MQSeries and related protocols. No ability exists to allow information to be shared between disparate systems or to facilitate components on disparate systems to be accessed in a manner consistent with embedded business logic or processes in the absence of substantial maintenance or new software development. The prior art further includes information exchange protocols that allow for data to be exchanged between disparate systems using an open-ended structured format and common structuring techniques, such as EDI, SGML, XML and HTML. While this allows data be shared in a sense, the receiver of a communication must previously know the fixed organization and structure of the underlying data to make use of it in accordance with business logic or processes. Further, such protocols do not by themselves facilitate managing the transfer or processing of information across disparate systems. The prior art also includes attempts to avoid limitations of foundational and information exchange protocols by combining them to permit component-based access across disparate systems, such as UDDI, SOAP and XML-RPC. None of these provide adequate means, however to manage or develop tools for interoperability requirements and shares many of the underlying disadvantages of the underlying protocols they embody.

Attempting to avoid the limitations of these protocols, the prior art evolved business process exchange protocols that combined favorable elements of foundational, informational and processing exchange protocols to define and act upon common day to day activities and or business processes, such as BizTalk Framework, ebXML, RosettaNet, .Net Hailstorm, WDL and WSFL. None of these, however provide an adequate, generalized solution to the problem, because these “standards” provide interoperability at the cost of imposing a structure on existing business processes, requiring tools for conversion and adapting to those standards. Not all legacy systems may be quickly and cost-effectively modified to adapt to particular protocols or standards. To the extent an enterprise obtains commercial advantage from unique business processes, such systems offer a peculiar Hobson's choice between standardized interoperability and adaptability to cutting-edge processes.

Some prior art permits the ready flow of data from device and system to another, without providing facilities for interpreting or processing that data as information. Still other systems facilitate managing information in the context of business systems, without providing facilities for managing the flow of the information across disparate systems to exercise enterprise business processes. None of the prior art systems provide for the steady two-way flow of information across disparate systems and devices; the capacity for making and answering requests to and from component processes and business processes between disparate systems and devices; the capacity to manage component process flow and business process flow among disparate systems and devices; the capacity to manage such component process flow and business process flow dynamically, adapting to changes in an enterprise information infrastructure; and the capacity to feasibly and dynamically configure the systems, devices, component processes and business processes to interoperate consistent with the constraints and requirements of the enterprise.

Accordingly, a global protocol and device independent enterprise integration application is needed to reduce the costs and complexity of adding additional devices and systems to a particular user's existing systems and devices, while provided an agile facility to adapt to new devices and systems as they are introduced to the marketplace. To date, the problem preventing a solution to this need has been the lack of a completely open, configurable and intelligent architecture that can accomplish the recognition, configuration, translation and communication functions required. The present invention enables the enterprise to leverage facilities of the prior art by providing this missing link. The present invention enables system integration consistent with these properties by providing a superset of prior art protocols manifest and integrating through a novel architecture and framework.

### SUMMARY OF THE INVENTION

A protocol-independent method for processing messages in an enterprise integration application system. The system comprises host processors for managing the flow of information throughout the system, channel processors for operatively communicating between two processors in the system, and legacy processors that provide the underlying business logic used by the system. The system operates by installing at least one host processor and at least one channel processor. A message having a message key is received at a target host processor via a channel processor. Configuration information is dynamically maintained throughout the system for each host processor in accordance both with the communications topology and the business process requirements of the system. The configuration information includes an association between each channel processor and a corresponding host processor, an association between the target host processor and immediately communicating channel processors, and an association between message keys and corresponding destination data. The message is forwarded to a corresponding channel processor in accordance with the specification set forth in the dynamic configuration information, so that messages originating from a channel processor are dynamically routed through the enterprise integration application system in accordance with said association between message keys and destination data.

### BRIEF DESCRIPTION OF THE DRAWINGS

FIG. 1 illustrates an exemplary system with a plurality of components in accordance with one embodiment of the present invention.

FIG. 2 is a schematic diagram of a hardware implementation of one embodiment of the present invention.

FIG. 3 illustrates an enterprise integration application in accordance with one embodiment of the present invention.

FIG. 4 is exploded schematic of the encircled portion of FIG. 3 in a preferred embodiment of the present invention.

FIG. 5 is a flowchart of a protocol-independent method for processing messages in an enterprise integration application system in accordance with one embodiment of the present invention.

FIG. 6 is a flowchart of a process detailing the act of maintaining dynamic configuration information for a host processor in an enterprise integration application in accordance with one embodiment of the present invention.

FIG. 7 illustrates a message format in accordance with one embodiment of the present invention.

FIG. 8 is a flowchart of a process detailing the act of forwarding messages illustrated in FIG. 5 in an enterprise integration application system in accordance with one embodiment of the present invention.

FIG. 9 illustrates a message format for a transfer message in accordance with one embodiment of the present invention.

FIG. 10 is a flowchart of a process detailing the act of determining destination data as illustrated in FIG. 8 in an enterprise integration application system in accordance with one embodiment of the present invention.

FIG. 11 is a flowchart of a process detailing the act of preparing a forwarding message as illustrated in FIG. 8 in an enterprise integration application system in accordance with one embodiment of the present invention.

FIG. 12 illustrates a window of a graphic user interface for specifying a host processor communication configuration of an enterprise integration application in accordance with one embodiment of the present invention.

FIG. 13 illustrates a window of a graphic user interface for displaying a system-level configuration of an enterprise integration application in accordance with one embodiment of the present invention.

### DETAILED DESCRIPTION

As the scope of business and individual computing has grown, businesses and individuals find themselves needing more and more to interact with information and business processes housed in a variety of disparate systems and devices. As companies merge with, acquire or form strategic alliances with one another, they find themselves encumbered with the additional workload to define and integrate the scattered business processes and information on numerous disparate systems and devices. Individuals, too, find themselves caught in a similar dilemma as they obtain and attempt to integrate the latest hardware devices and software systems, and to interact with their systems at work. In part, this system is further exacerbated by the lack of agreement to a single data structure, mode of communication and processing standard, resulting in an almost daily creation of new proposed data structures and processing standards. Accordingly, a need has arisen for an enterprise integration application that provides enterprise-wide interoperability between disparate systems, be they local infrastructure, national infrastructure or global in nature. As the industry develops new and superior protocols and standards for devices, operating systems, languages and data structures, consumers of these products need to be shielded from the frustration and additional workload arising from the concomitant incompatibilities.

As used here, the word “system” refers to any form of functionality for processing enterprise information, and may refer to individual software components within a program, entire programs or program components, machines and devices that run or manage systems, combinations and networks of such machines and devices, and even individuals or combinations of individuals manually exercising business processes, possibly with or without a machine or device. For convenience, we shall refer to a system operating on a device such as a computer as a “processor.” As with systems, a processor may advantageously serve as a single piece of software running on a computer, an entire computer program or component, a computer running a complex system, a network or collection of computers. Systems may interoperate by passing data to and from other systems using communication channels. Channels of communication might advantageously include shared memory, intra-system software architectures, traditional input-output channels such as parallel or serial ports, and modern networking capabilities such as Ethernet and other devices.

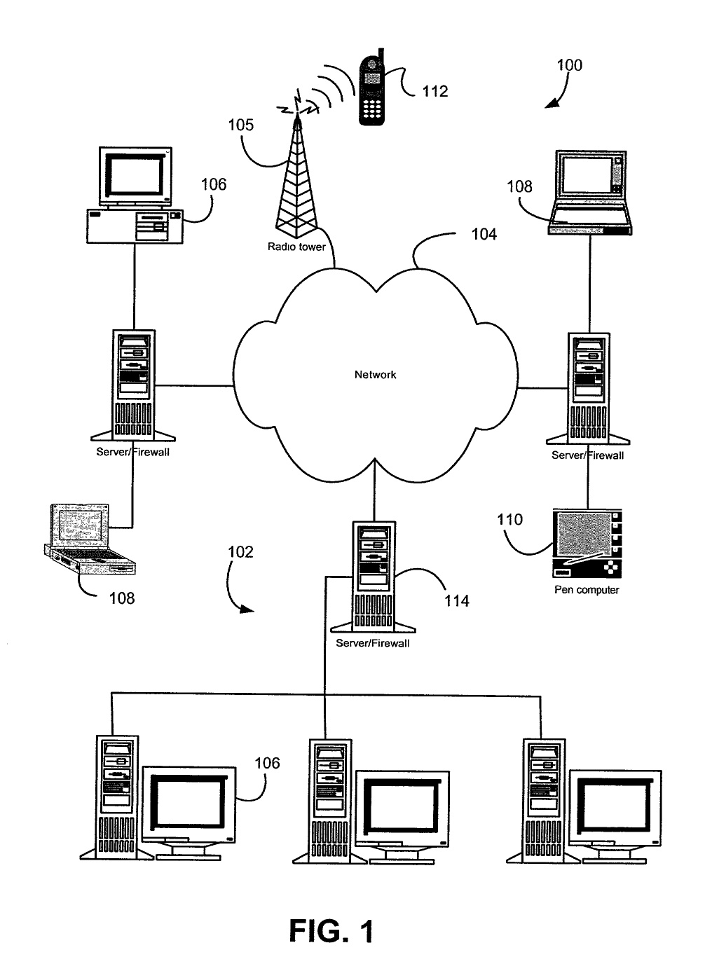

FIG. 1 illustrates an exemplary system 100 with a plurality of components 102 in accordance with one embodiment of the present invention. As shown, such components include a network 104 which take any form including, but not limited to a local area network, a wide area network such as the Internet, and a wireless network 105. Networks communications may be connectionless, as with TCP/IP networks, or connection based, as with ATM networks. Coupled to the network 104 is a plurality of computers which may take the form of desktop computers 106, laptop computers 108, hand-held computers 110 (including wireless devices 112 such as wireless PDA's or mobile phones), or any other type of computing hardware/software. These computers may be lined directly with one another via Ethernet, serial lines or other means. As an option, the various computers may be connected to the network 104 by way of a server 114 which may be equipped with a firewall for security purposes. The firewall may or may not directly permit each component to interact using the same protocols, and may require one machine to interact with another using virtual private networks, ftp, smtp or other alternative protocols. It should be noted that any other type of hardware or software may be included in the system and be considered a component thereof.

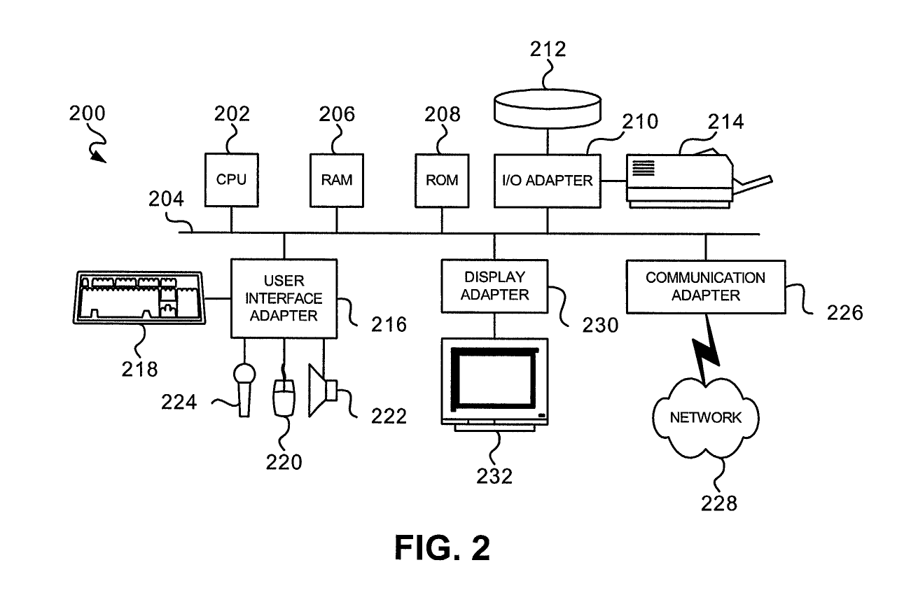

A representative hardware environment associated with the various components of FIG. 1 is depicted in FIG. 2. In the present description, the various sub-components of each of the components may also be considered components of the system. For example, particular software modules executed on any component of the system may also be considered components of the system. FIG. 2 illustrates an illustrative hardware configuration of a workstation 200 having a central processing unit 202, such as a microprocessor, and a number of other units interconnected via a system bus 204.

The workstation shown in FIG. 2 includes a Random Access Memory (RAM) 206, Read Only Memory (ROM) 208, an I/O adapter 210 for connecting peripheral devices such as, for example, disk storage units 212 and printers 214 to the bus 204, a user interface adapter 216 for connecting various user interface devices such as, for example, a keyboard 218, a mouse 220, a speaker 222, a microphone 224, and/or other user interface devices such as a touch screen or a digital camera to the bus 204, a communication adapter 226 for connecting the workstation 200 to a communication network 228 (e.g., a data processing network) and a display adapter 230 for connecting the bus 204 to a display device 232.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP may be understood to comprise two layers. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Although some packets from the same message may be routed along differently paths, all the packets will be reassembled after reaching the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Computers are at times connected to the Internet through via the Serial Line Internet Protocol (SLIP), the Point-to-Point Protocol (PPP), the Point-to-Point Protocol over Ethernet (PPPoE) or similar protocols. These protocols encapsulate IP packets so that they can be sent over a dial-up phone connection or DSL line to an access provider's modem.

Other protocols related to TCP/IP include the User Datagram Protocol (UDP), which is used instead of TCP for special purposes. Other protocols are used by network host computers f or exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPTP). Microsoft has extended Windows NT to support PPTP. A comparatively new internet standard for implementing a VPN over the network is known as IPSec.

A firewall server may use various technologies to filter against certain kinds of network communications. Accordingly, not every network protocol can be used to communicate with every machine across a firewall. While this serves to facilitate maintenance of security by restricting the nature of communications across networks, it can make legacy systems unable to interoperate across the firewall unless the systems are programmed to communicate via allowable means. Applications called proxies are sometimes used to facilitate limited access to information across a firewall. However, legacy systems may not be programmed in a manner that permits it to access data via such a proxy. VPN software is frequently installed as part of a company's firewall server.

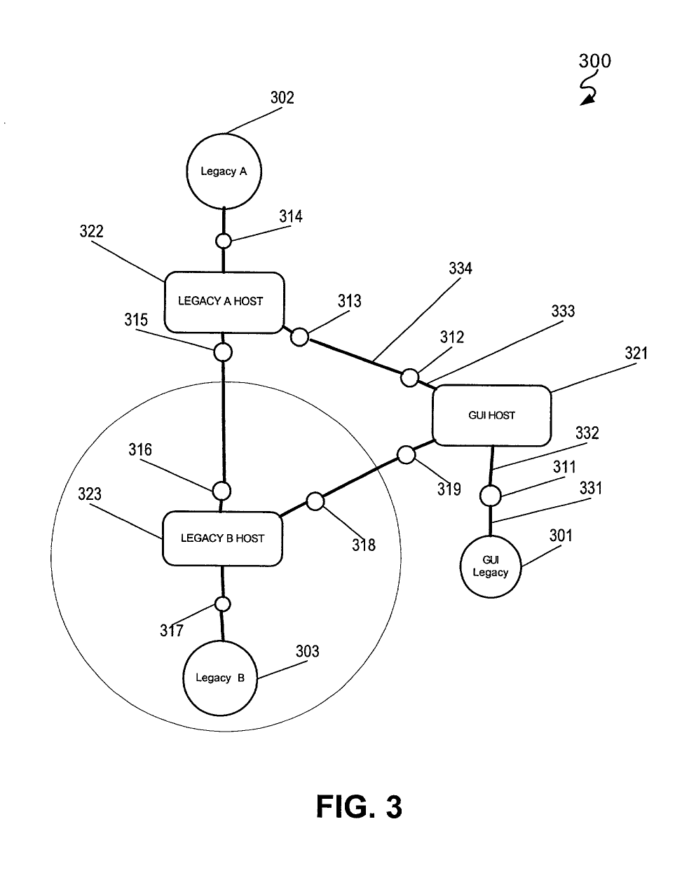

FIG. 3 illustrates a preferred embodiment of an integrated enterprise application 300 having a number of legacy processors 301 through 303, a number of channel processors 311 through 319 and a number of host processors 321 through 323. The legacy processors 301 through 303 may be of vastly disparate type and communicate through a variety of incompatible data formats and means. The enterprise desires to have the legacy processors interact in accordance with a set of business processes. This is accomplished by providing channel processors 311 through 319 to communicate with the legacy processors for interaction with the host processors 321 through 323. Host processors facilitate controlling, routing and directing the flow of information throughout the enterprise integration application. As indicated in FIG. 3, channel processors may also communicate between host processors.

In practice, each channel processor 311 through 319 may advantageously communicate with at least two processors across communication paths 331 through 334 in a manner depending upon a predetermined set of channel processor types. In FIG. 3, for example, channel processor 311 communicates via a serial connection path 331 with legacy processor 301, and communicates via COM connection path 332 with host processor 321. Channel processors may also communicate with other channel processors. Examining FIG. 3, for example, channel processor 312 communicates via COM connection path 333 with host processor 321 and via an Ethernet TCP/IP connection path 334 with channel processor 313. In a preferred embodiment, host processors 321 through 323 direct the flow of traffic throughout the enterprise integration application 300 in accordance with an initially predetermined, configurable and dynamically maintainable set of process instructions.

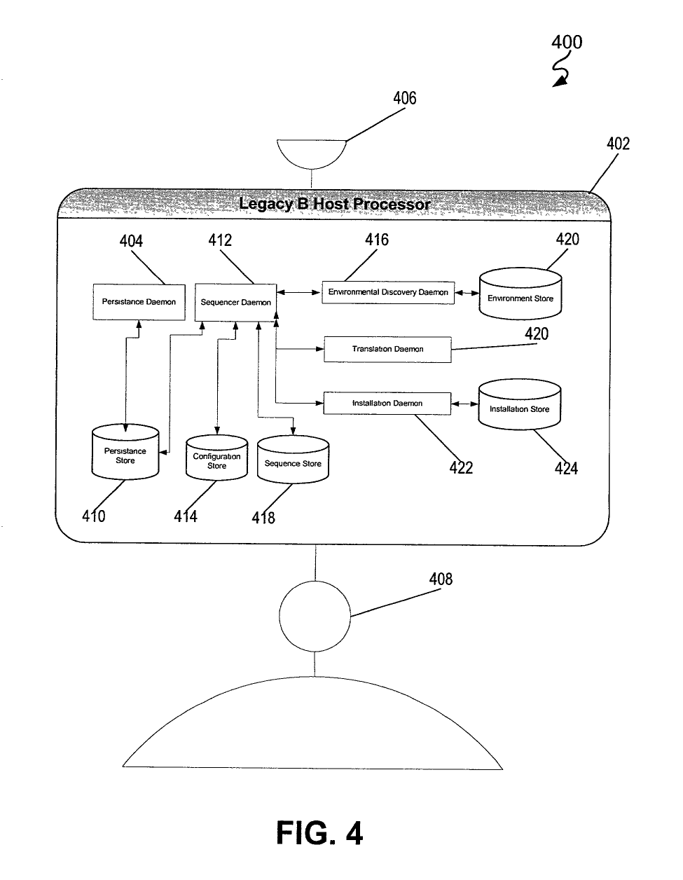

FIG. 4 is an exploded schematic representation of the encircled portion of FIG. 3 in a preferred embodiment of the present invention. Examining FIG. 4, it can be seen that the host processor 402 may advantageously comprise various elements. A persistence daemon 404 is primarily responsible for receiving messages (not shown) from associated channel processors 406, 408, and maintaining the messages (not shown) in a persistence store 410 for retrieval and routing by a sequencer daemon 412.

FIG. 4 shows a sequencer daemon 412, which may advantageously direct the flow of operations for the host processor 402. In operation, the sequencer daemon is responsible for starting up (either upon initialization or in a just in time fashion), and sending messages (not shown) to, associated channel processors 406, 408. The sequencer daemon 412 is responsible for establishing the host processor 402 configuration from a configuration store 414, adjusting and maintaining the configuration, including interaction with an environmental discovery daemon 416 and messages (not shown) received from the persistence store 410 and providing for the processing and routing of messages (not shown) by the host processor 402 via associated channel processors 406 and 408 in accordance with the data retained in the configuration store 414. Sequence routing information may conveniently be maintained for speedy retrieval by the sequencer daemon 412 in a separate sequence store 418, as may information concerning the overall network configuration be maintained for speedy retrieval by the environmental discovery daemon 416 in an environment store 420.

The configuration store 414 represents a detailed description both of the overall architecture and topology of the enterprise integration application 300 and the steps and business logic necessary for it to operate. As shown in Table 1 below, and as more particularly described herein, the configuration store 414 includes information concerning: (i) host processors and their organization into a hierarchy of clusters, sometimes referred to as communities and neighborhoods; (ii) information concerning the association of channel processors with host processors, and whether such channel processors should be installed and run upon the initialization of a host processor, or may be started “just in time” to process a message; (iii) information concerning the nature of channel processors, including their instantiation methodologies, communication protocol information and associated outcome indicia; (iv) template and macro information to facilitate the specification of the enterprise integration application structure and topology.

TABLE 1
General Structure of Configuration Store

List of Host Processor Communities, and for each community:

Community Identification
List of Neighborhoods associated with the community

List of Host Processor Neighborhoods, and for each
neighborhood:

Neighborhood Identification
List of Host Processors associated with the neighborhood

List of Host Processors, and for each host processor:

Host Processor Identification
Convenient Description String
List of Channel Processors associated with the Host Processor, and for each
channel processor, whether the channel processor should be
instantiated upon startup

List of Channel Processors, and for each channel processor:

Channel Processor Identification
Convenient Description String
Instantiation Methodology
Configuration Information
Communication Protocol Information
List of Outcome Indicia associated with the channel processor
Association of Destinations and Message Keys
Template Specifications

Accordingly, routing, as that term is used in accordance with the present invention, accomplishes not only a protocol independent transfer of data and information between legacy processors as, for example, might be accomplished in the prior art, albeit in a protocol dependent fashion, by TCP/IP routers; but routing as used here also manages the sequencing, translation and organization of the manner in which that data is processed as, for example, might be accomplished, albeit without capabilities for adapting to dynamic changes in application structure, underlying communications protocols and network infrastructure, by prior art protocol-specific enterprise integration applications.

FIG. 4 further illustrates how a sequencer daemon may further direct the installation of a channel processor via an installation daemon 422. The installation daemon may maintain software to automatically facilitate such installations in an installation store 424, either on a scheduled or “just-in-time” basis. The sequencer daemon 412 may also advantageously facilitate calls to a channel processor for purposes of data translation by directly effecting the translation with a translation daemon 426. Other more common enterprise integration application functionality may likewise be simulated within a host processor.

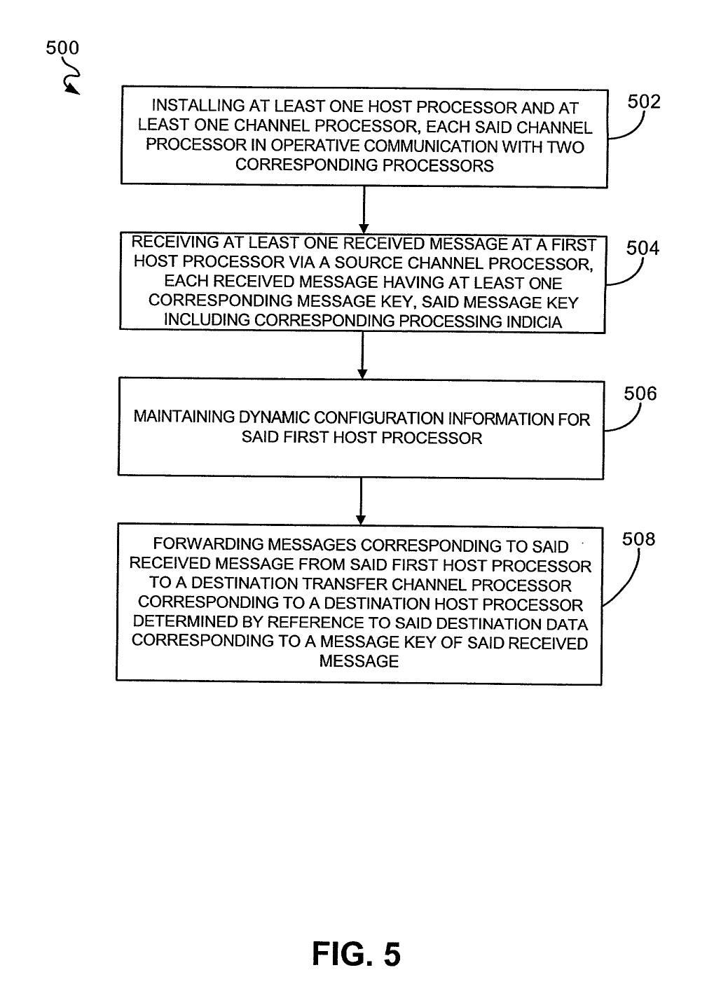

Examining FIG. 5, a preferred embodiment of a protocol-independent method 500 for processing messages in an enterprise integration application system in accordance with the present invention is shown. The method entails the act of installing 502 at least one host processor and at least one channel processor, with each channel processor in operative communication with two corresponding processors of varying type. The method further entails the act of receiving 504 at least one message (the “received message”) at a host processor (the “first host processor”) via a channel processor (the “source channel processor”). Each received message has at least one corresponding message key, the message key including corresponding processing indicia as described herein. In an aspect, the received message may have plural message keys including a distinguished key (the “primary message key”). The method still further entails the act of the act of maintaining 506 dynamic configuration information for the first host processor, as further described herein and the act of forwarding 508 messages corresponding to the received message from each the first host processor to a channel processor (the “destination transfer channel processor”), as further described herein.

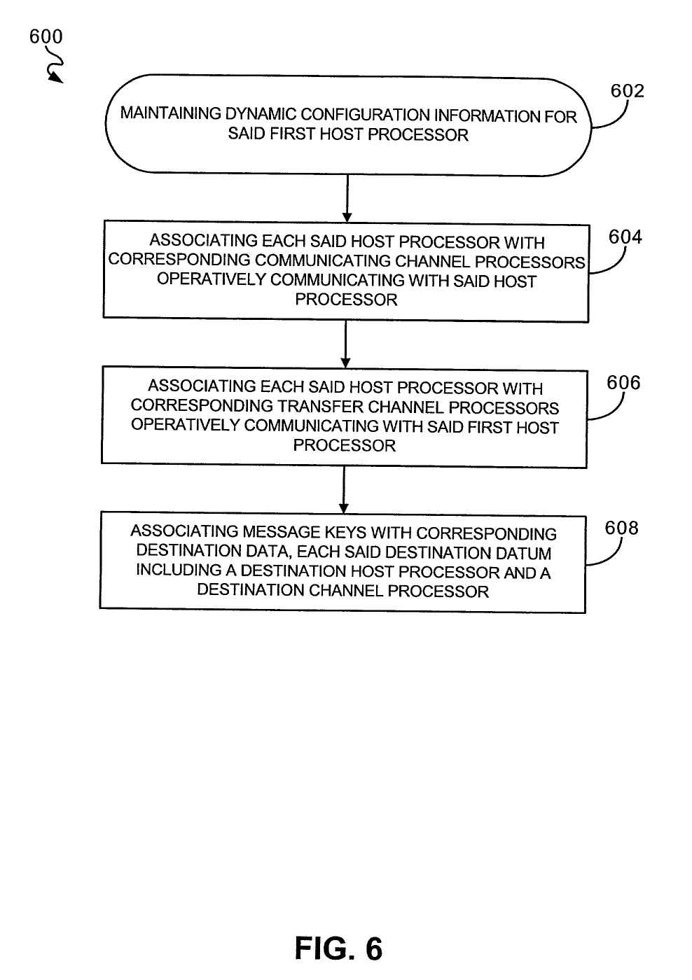

FIG. 6 farther illustrates details of the act of maintaining 506, 600 dynamic configuration information for the first host processor. Maintaining 506, 600 includes the act of associating each the host processor with corresponding communicating channel processors 602 operatively communicating with the host processor. Maintaining 506, 600 further includes the act of associating each the host processor with corresponding channel processors (the “transfer channel processors”) 604 operatively communicating with the first host processor. Maintaining 506, 600 also includes the act of associating message keys 606 with corresponding data defining the destination for the received message, each destination datum including a host processor (the “destination host processor”) and a channel processor (the “destination channel processor”).

In this context, looking again to FIG. 5, it can be seen that the act of forwarding 508 messages corresponding to the received message from the first host processor to a destination transfer channel processor is accomplished via the destination transfer channel processor corresponding to a destination host processor determined by reference to the destination data corresponding to a message key of the received message. In this manner messages originating from a channel processor are dynamically routed through the enterprise integration application system in accordance with the association between message keys and destination data.

In an aspect, the method 500 may advantageously include the act of maintaining and updating dynamic configuration information for the first host processor based upon a contents of the received message. In another aspect, the act of maintaining 506, 600 dynamic configuration information for the first host processor may further include the act of associating each the transfer channel processor with a communication protocol specification selected from at least two communication protocol specifications; and the act of forwarding 508 may further includes the act of conforming with the communication protocol specification associated with the destination transfer channel processor. In still another aspect the system may includes at least one legacy or terminal processor and the act of associating message keys with corresponding destination data depends upon conforming to a predetermined set of rules relating to the integration and operation of the at least one terminal processor into the enterprise integration application. In this case, the business rules may include rules providing for the translation of data from one termination application into a format suitable for use for a second termination application.

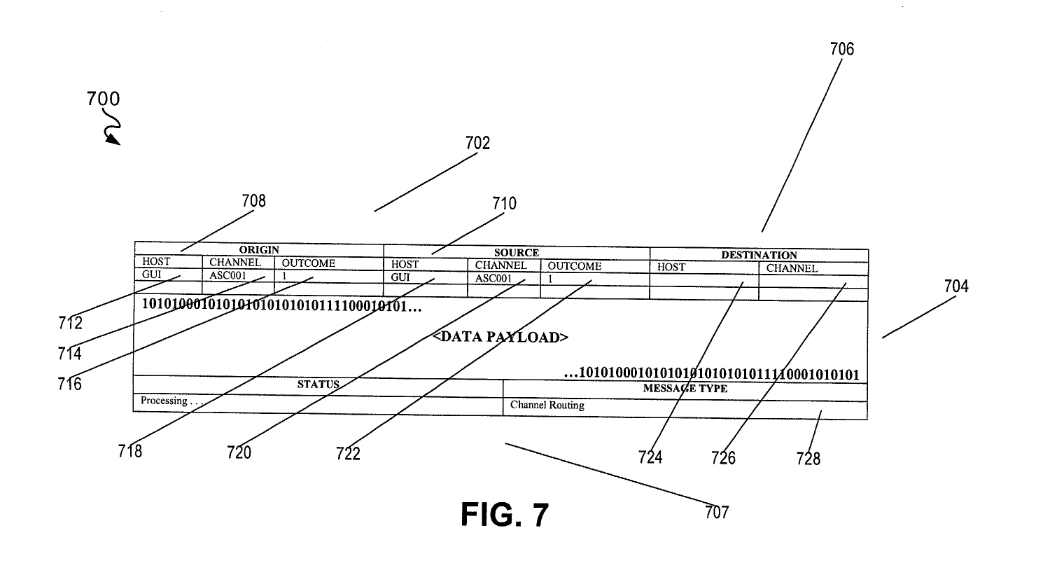

FIG. 7 illustrates a message format 700 suitable for use with the disclosed invention. A person of ordinary skill in the art will appreciate that message format 700 is but one of many possible message formats that may be used in accordance with the disclosed method. The message format 700 comprises at least one message key generally indicated as 702, a message payload generally indicated as 704 and may advantageously include additional information generally indicated as 706. The additional information 706 and 707 may be advantageously maintained by the enterprise integration application to assist in the routing or processing of a message therethrough.

FIG. 7 further illustrates how, in a preferred embodiment, each message key 702 may include origin message key data generally indicated as 708 and source message key data generally indicated as 710. The origin message key data 708 identifies an originating host processor 712, an originating channel processor 714 and an outcome indicator 716 selected from a predetermined set of outcome indicia associated with the identified originating channel processor. The source message key data 710 identifies a source host processor 718, a source channel processor 720 and a source outcome indicator 722 selected from a predetermined set of outcome indicia associated with the identified source channel processor. In a preferred embodiment, outcome indicia may include or embody codes relating to the success or failure of a particular operation associated with a message or relating to the result of a particular operation associated with a message.

FIG. 7 illustrates the data payload 710 in accordance with the present invention. The data payload 710 comprises message data comprehensible to the processor for which it is targeted, but in a preferred embodiment may include data describing its format, interpretation and arrangement using notation that will be familiar to persons of ordinary skill in the art. In one preferred embodiment, for example, the data payload may comprise an XML-based description of an underlying raw data payload, together with the raw data payload. In the preferred embodiment the additional information 706 may include information identifying a destination host processor 724 and a destination channel processor 726 associated with the message 700, and the additional information 707 may include information indicating a message type 728, indicating how message keys set forth in a message should be interpreted.

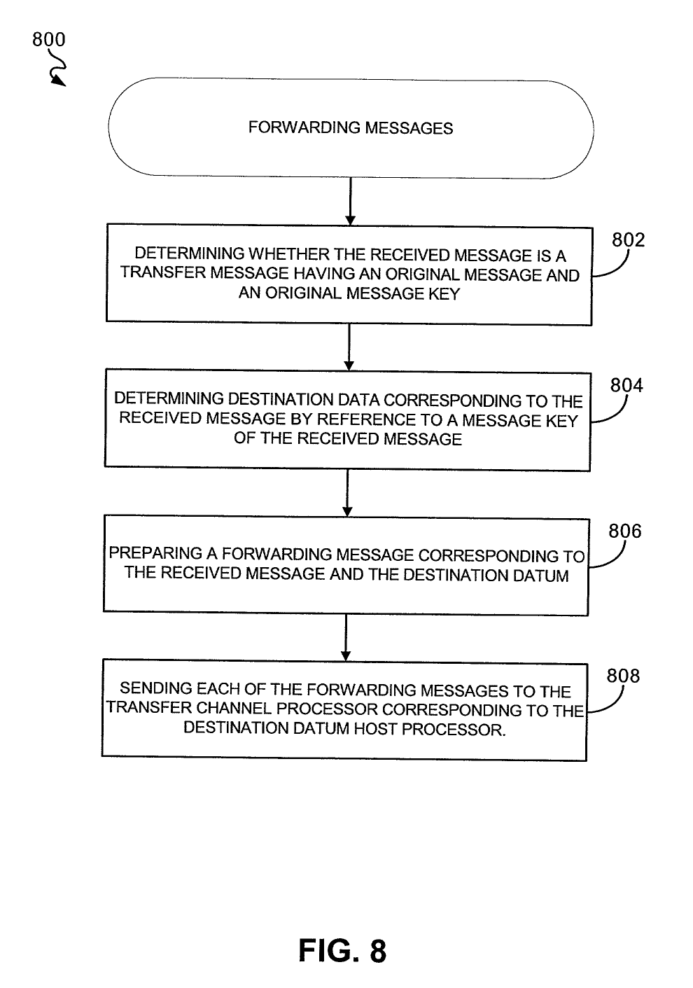

FIG. 8 further illustrates further details of the act of forwarding messages 508, 800. The act of forwarding messages 508, 800 may advantageously include the act of determining whether the message is a transfer message 802 having an original message and an original message key. The act of forwarding messages 508, 800 may further include the act of determining destination data 804 corresponding to the received message by reference to a message key of the received message. The act of forwarding messages 508, 800 may still further include the act of preparing 806 a forwarding message corresponding to the received message and the destination datum. And the act of forwarding messages 508, 800 may include the act of sending 808 each the forwarding message to the transfer channel processor corresponding to the destination datum host processor.

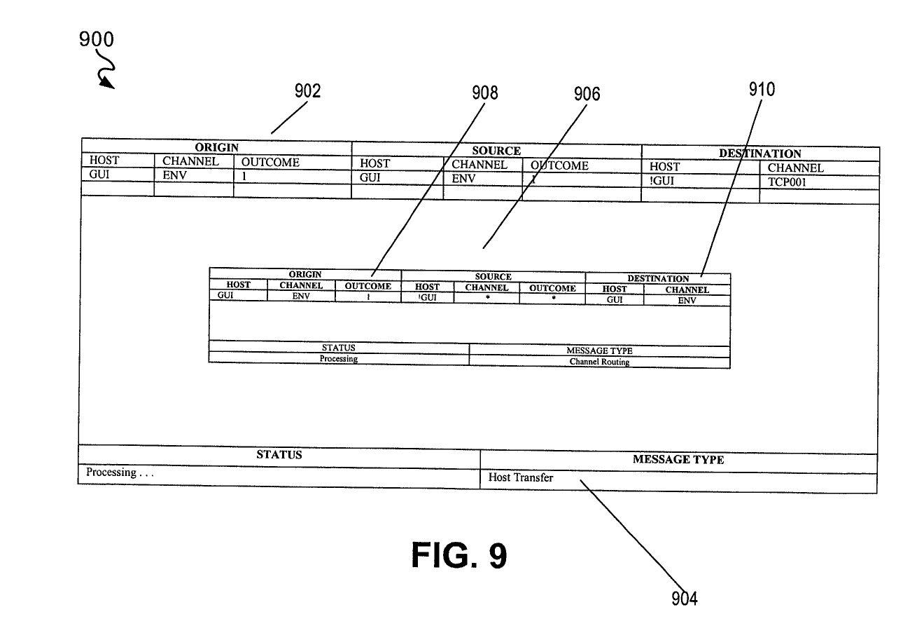

FIG. 9 illustrates a transfer message generally indicated as 900 in accordance with an embodiment of the disclosed invention, using a message format of the kind shown in FIG. 7. The transfer message 900 has a primary message key generally indicated as 902. FIG. 9 illustrates the use of a message type field 904 to indicate that a message is a transfer message having on original message generally indicated as 906 having an original message key 908. Advantageously, the transfer message may, but need not also conveniently store a destination host processor and channel processor stored as additional information 910. As a person of ordinary skill in the art will understand, a transfer message may be stored using many different formats providing substantially the same information or its equivalents.

In an aspect, a message type for routing overrides may be supported using the message format indicated in FIG. 9 to provide for the override of business logic message routing to a fixed destination 910. In another aspect, a message type for reconfiguring message routing in a host processor may be supported using the message format indicated in FIG. 9 to provide for reconfiguring a host processor to route future messages to a message key 908 to a destination 910.

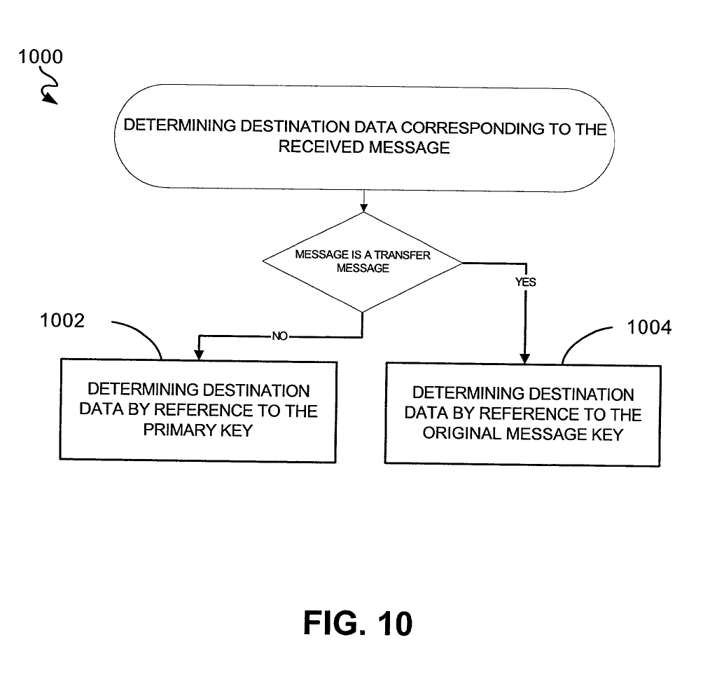

FIG. 10 further illustrates details of the act of determining destination data 804, 1000 corresponding to a received message in one embodiment of the present invention. The act of determining destination data 804, 1000 may include the act determining destination data by reference to the primary key 1002 when the received message is not a transfer message; and otherwise determining destination data by reference to the original message key 1004.

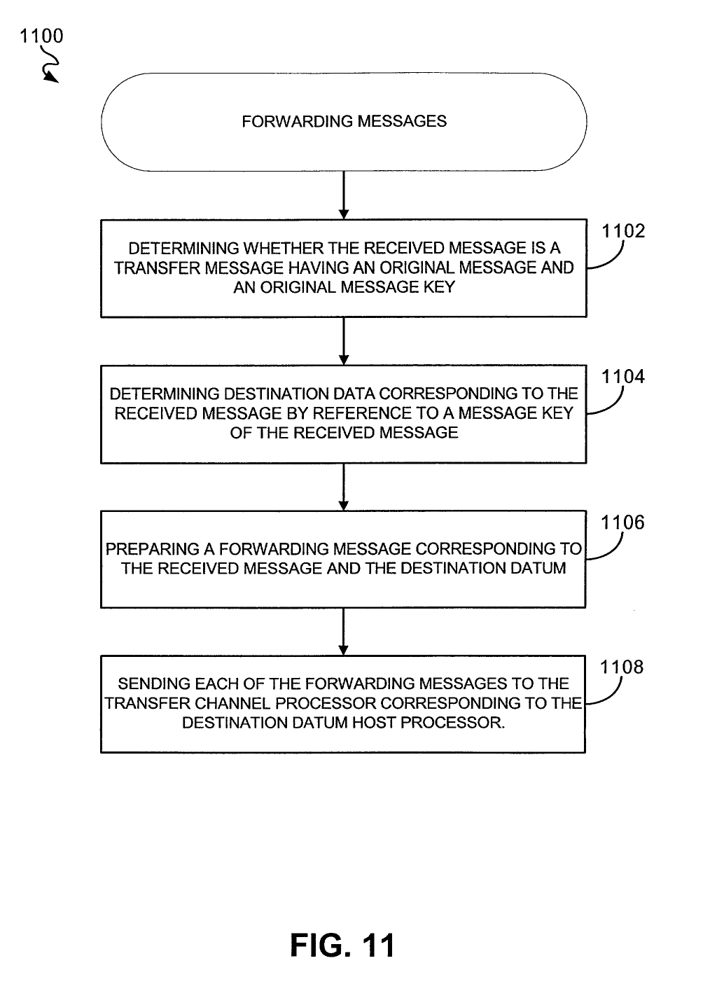

FIG. 11 further illustrates details of the act of preparing a forwarding message 806, 1100 in one embodiment of the present invention. The act of preparing a forwarding message 806, 1100 may include the act of determining whether the received message is a transfer message 1002 having an original message and an original message key. In the case where the received message is a transfer message and the destination host processor is the first host processor, the act of preparing a forwarding message 806, 1100 as illustrated therein includes the act of preparing a message substantially similar to the included message 1102. In the case where the received message is not a transfer message and the destination host processor is not the first host processor, the act of preparing a forwarding message 806, 1100 as illustrated therein includes the act of preparing a transfer message including the received message. In other cases, the act of preparing a forwarding message includes the act of preparing a message substantially similar to the received message.

As Illustrated in FIG. 9, host processor identifiers and channel processor identifiers within a message key may optionally be represented using a notation capable of specifying a plurality of identifiers. A preferred embodiment uses a regular expression notation, such as the syntax used in Unix egrep or penl, to denote sets of host processor identifiers and channel processor identifiers within a message key. In operation, host processor regular expressions in a message key may be compared against lists of host processors and channel processor regular expressions in a message key may be compared against lists of channel processors maintained in the configuration store or the sequence store to determine the set of processors denoted by an expression. Further in operation, by reference to FIG. 10, during the act of determining destination data corresponding to a received message 1000, destination data may be determined with respect to any message key or message keys matching the processor regular expressions embodied with the key or keys.

As shown above, the organization of an enterprise integration application around a dynamic configurable store is tremendously flexible for operating a dynamic enterprise integration application. However, the manual creation or manual maintenance of a complete specification for a configuration store of a system even of modest complexity can be an arduous and error-prone task. In a preferred embodiment of the present invention, the configuration store is initially specified through a combination of manual specification of certain portions of the enterprise application configuration and automatic computation of unspecified data resulting therefrom. In the preferred embodiment, the configuration store is likewise maintained by a combination of manual specifications and automatic computation of unspecified data resulting therefrom.

In the preferred embodiment, each host processor retains a representation of the most recently used configuration store. In the absence of such representation, the host processor uses instead a predetermined default configuration store. The administrator may then additionally specify one or more of a predetermined set of channel processor descriptions (the “communicating channel processor descriptions”) for channel processors to be associated with the host processor. The communicating channel processor description will define communication protocols for specifying how corresponding channel processors may communicate with other host processors. In the preferred embodiments, such communication protocols may include IP Sockets, Serial Ports, COM Ports, Disk 10 or other means by which processors may interoperate. The communicating channel processor description may further define default parameters associated with such communication protocols. In the preferred embodiment, default parameters may include a default range of identifiers of potential processors (the “scanning processor range”) that may be found upon initialization. For example, a scanning processor range for an IP Sockets channel processor may constitute a subnet of IP addresses. The administrator may manually modify the default parameters.

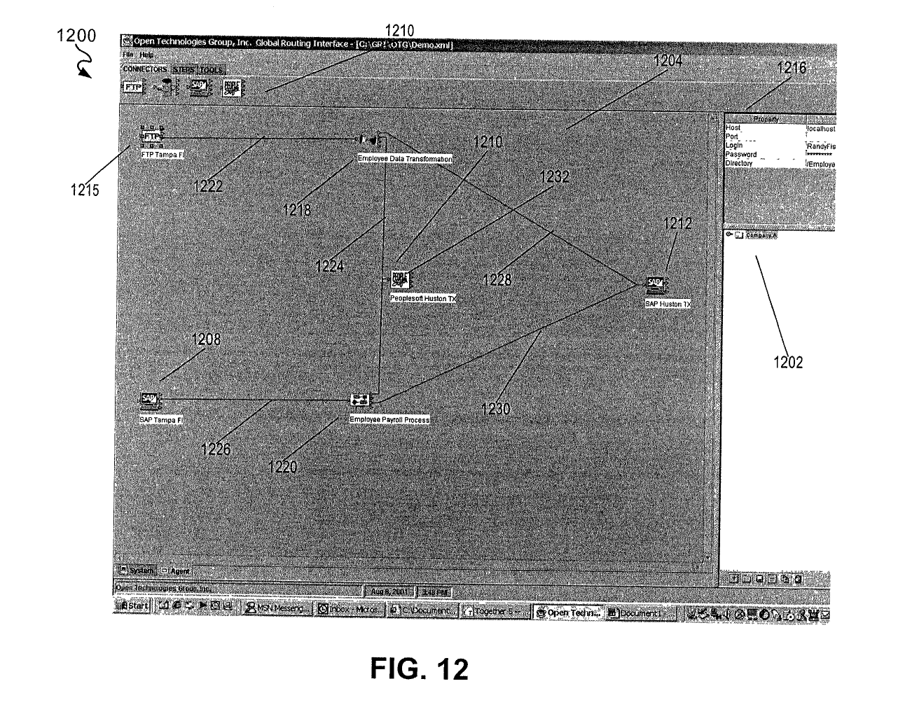

FIG. 12 illustrates a graphic user interface window 1200 for specifying the communication configuration of a host processor 1202 in accordance with one embodiment of the present invention. In a principal pane 1204 of the graphic user interface window 1200 permits the placement of icons 1206 through 1212 representing instantiations of classes of communicating host processors from a predetermined set of processors selected from a palate 1214. Default parameters corresponding to the communicating channel processor description for a given host processor icon 1202 are displayed in a second pane 1216, which further may be modified or edited by a system administrator. Upon manually specifying the communication configuration of each host processor, as was done in host processor 1202, host processors may be then started for a protocol-independent automatic determination of the overall enterprise integration application communication configuration.

FIGS. 3, 4 and 9 may be referred to illustrate an initialization sequence of a host processor in the present invention. In a preferred embodiment, during initial startup of a host processor 321, 402, the sequencer daemon 412, will attempt to communicate with other host processors using associated communicating channel processors 311, 312, 319, 406, 408. The sequencer daemon 412 invokes the environmental discovery daemon 416, which in turn prepares one or more messages 900 (the “discovery request messages”) for transmittal to each associated communicating channel processor processors 311, 312, 319, 406, 408 associated with the scanning processor range associated with the corresponding communication channel processors 311, 312, 319, 406, 408 and in turn their associated host processors (the “responsive host processors”). These messages are then sent using regular expression message keys via the sequencer daemon 412.

Upon receipt of a discovery request message, a responsive host processor or channel processor returns a message (a “discovery response message”), bearing error information or a data payload including further detailed information concerning the configuration store of responsive host processors. Each responsive host processor may, in turn, produce additional discovery request messages in order to obtain information from the environment of the responsive host processor to prepare a discovery response message. Upon receiving replies (or by the passing of a predetermined time out period before receiving a reply), the environmental discovery daemon 416 running in the originating host processor 321, 402 may infer environmental information about the information. An overall reachable topology and present least cost routing information may be determined by a person of ordinary skill in the art of networking from such information using classical network algorithms for minimum spanning trees, shortest paths and network flows. The environmental information is retained in the environmental store 420, and the configuration store 414 and sequencing store 418 are updated accordingly.

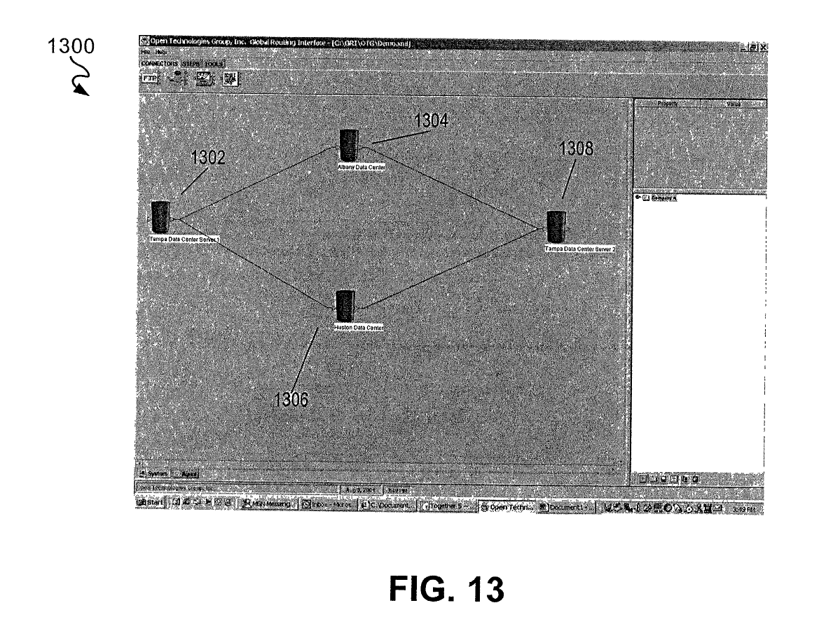

FIG. 13 illustrates a graphic user interface window 1300 for displaying a system-level configuration of an enterprise integration application in accordance with one embodiment of the present invention after an automatic configuration has been completed, displaying host processors 1302 through 1308

FIG. 12 further illustrates a graphic user interface window 1200 that advantageously may be used to define business logic integrating legacy systems throughout the enterprise integration application 300 once an overall enterprise integration application system topology has been manually specified and automatically completed as described herein. In addition to communication-based channel processors 1206 through 1212, process and transformation-based channel processors 1218 and 1220 may be specified and added to the host processor 1202 association of communicating channel processors. Connections 1222 through 1230 may be drawn from nibs 1232 adjacent to channel processors 1206 through 1220 corresponding to data inputs or to outcome results to indicate how information should be routed through the enterprise integration system. From this information and the communication information, a completed routing table corresponding to appropriate business logic may be determined and transmitted between host processors to create a complete and consistent configuration store and routing store for each host processor in the enterprise integration application. An illustrative configuration store represented in XML is given in table 2 below.

TABLE 2
XML Representation of Portion of Configuration Store

<?xml version=“1 0”encoding UTF-8”?>
<Agent fname=“Huston Data Center”>

<CONNECTOR type=“FtpConnector”bitmap=“FTP png” name=“WSC73101121140@52”fname=“FTP Tampa FL” x=“24” y=“249”>

<PROPERTY fname=“Host” name=“Host” value=“localhost” />
<PROPERTY fname=“Port” name=“Port” />
<PROPERTY fname=“Login” name=“Login” value=“RandyFisher” />
<PROPERTY fname=“Password” name=“Password” value=“*********” />
<PROPERTY fname=“Directory” name=“Directory” value=“EmployceInfo” />
<LINKS fname=”unserdef” name=“userdef” userdefinable=“1”>

<LINK fname=“System Disconnect” name=“System Disconnect” port=“output” />
<LINK fname=“Failed Login” name=“Failed Login” port=”output” />
<LINK fname=“Employee Information XML” name=“Employee Information XML” port=“output” nextstep=
“WSC73101121547@233” />
<LINK fname=“input” name=“input” port=“input” />

</LINKS >

</CONNECTOR>
<CONNECTOR type=“SAPConnector” bitmap=”SAP png” name=“WSC7310112133@145” fname=“SAP Tampa Fl” x=“30” y=“104”>

<PROPERTY fname=“User Name” name=“UserName” value=“RandyFisher” />
<PROPERTY fname=“Password” name=“Password” value=“********” />
<PROPERTY fname=“Server” name=“Server” value=“SAP Tampa” />
<PROPERTY fname=“Account” name=“Account ” value=“Account Executive“ />
<LINKS fname=“userdef” name=“userdef” userdefinable=“1”>

<LINK fname=“Customer Information” name=“Customer Information” port=“output” />
<LINK fname=“Employee Information” name=“Employee Information” port=“output” nextstep=“WSC73101122359@178” />
<LINK fname=“General Ledger” name=“General Ledger” port=“output” />
<LINK fname=“Parts” name=“Parts” port=“output” />
<LINK fname=“input” name=“input” port=“input” />

</LINKS>

</CONNECTOR>
<CONNECTOR type=“SAPConnector” bitmap=“SAP png” name=“WSC73101121417@180” x=“545” y=“89” fname=“SAP Huston TX“>

<PROPERTY fname=“User Name” name=“UserName” value=“RandyFisher” />
<PROPERTY fname=“Password” name=“Password” value=“*********” />
<PROPERTY fname=“Server” name=“Server” value=“SAP Tampa” />
<PROPERTY fname=“Account” name=“Account” value=“Account Executive” />
<LINKS fname=“userdef” name=“userdef” userdefinable=“1”>

<LINK fname=“Customer Information” name=“Customer Information” port=“output” />
<LINK fname=“Employee Information” name=“Employee Information” port=“output” />
<LINK fname=“General Ledger” name=“General Ledger” port=“output“ />
<LINK fname=“Parts” name=“Parts” port= output” />
<LINK fname=“input” name=“input” port= input” />

</LINKS>

</CONNECTOR>
<CONNECTOR type=“PSConnector” bitmap=“PS2 png” name=“WSC73101121444@16” x=“533” y=“264” fname=“Peoplesoft Huston TX”>

<PROPERTY fname=“Login Name” name=“UserName” value=“RandyFisher” />
<PROPERTY fname=“Password” name=“Password” value=“***************” />
<PROPERTY fname=“Account” name=“Account” value=“HR Director” />
<LINKS fname=“userdef” name=“userdef” userdefinable=“1”>

<LINK fname=“Employee Information” name=“success” port=“EmployeeInfo” />
<LINK fname=“General Department Information” name=“Department” port=“output” />
<LINE fname=“Full Department Information” name=“FullDepartment” port=“output” />
<LINK fname=“Open Requisitions by Department” name=“DepartmentReg” port=“output ” />
<LINK fname=“input” name=“input” port=“input” />

</LINKS>

</CONNECTOR>
<STEP type=“SomeRouteStep” bitmap=“UDT png” name=“WSC73101121547@233” x=“271” y=“46” fname=“Employee Data Transformation”>

<PROPERTY fname=“prop1” name=“SourceDataType” value=“SAP” />
<PROPERTY fname=“prop2” name=“DestinationDataType” value=“XML” />
<PROPERTY fname=“prop3” name=“Data Macro One” value=“” />
<PROPERTY fname=“prop4” name=“Data Macro Two” />
<LINKS fname=“userdefined” name=“userdef” userdefinable=“1”>

<LINK fname=“Employee Information with average salary” name=“EmployeeAvSalary” port=“output” nextstep=
“WSC73101121417@180” />
<LINK fname=“Full Employee Information” name= FullEmployeeInfo” port=“output” nextstep=“WSC73101121444@16” />
<LINK fname=“Summary Employee Information” name=“SummaryEmployeeInfo” port=“output” />
<LINK fname=“Department Average Salary” name= DepartmentAvSalary” port=“output” />
<LINK fname=“Department job listings” name=“DepartmentJobListing” port=“input” />

</LINKS>

</STEP>
<STEP type=“SomeRouteStep” bitmap=“bp png” name=“WSC73101122359@178” fname= Employee Payroll Process” x=“273” y=“275”>

<PROPERTY fname=“prop1” name=“Projection Start Date” value=“Current Date” />
<PROPERTY fname=“prop1” name=“Projection End Date” value= Current Date + 3 Months” />
<PROPERTY fname=“prop2” name=“Department Number” value=“Sales - 303” />
<LINKS fname=“userdefined” name=“userdef” userdefinable=“1”>

<LINK fname=“Employee Salary Projections” name=“Employee Salary Projections” port=“output nextstep=
“WSC73101121417@180” />
<LINK fname=“Summary Daily Sales Projections” name=“Summary Daily Sales Projections” port=“output” />
<LINK fname=“Employee Vacation XML” name=“Employee Vacation XML” port=“output” nextstep=“WSC73101121444@16” />
<LINK fname=“Employee Vacation TXT” name=“Employee Vacation TXT” port=“output” />
<LINK fname=“input” name= “input” port=“input” />

</LINKS>

</STEP>

</Agent>

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A protocol-independent method for processing messages in an enterprise integration application system having at least three processors, comprising the acts of:
installing at least one host processor and at least one channel processor, each said channel processor in operative communication with two corresponding processors;
receiving at least one received message at a first host processor via a source channel processor, each received message having at least one corresponding message key, said message key including corresponding processing indicia;
maintaining dynamic configuration information for said first host processor, including the acts of:
associating each said host processor with corresponding communicating channel processors operatively communicating with said host processor;
associating each said host processor with corresponding transfer channel processors operatively communicating with said first host processor;
associating message keys with corresponding destination data, each said destination datum including a destination host processor and a destination channel processor;
forwarding messages corresponding to said received message from said first host processor to a destination transfer channel processor corresponding to a destination host processor determined by reference to said destination data corresponding to a message key of said received message;
whereby messages originating from a channel processor are dynamically routed through said enterprise integration application system in accordance with said association between message keys and destination data

2. The method in claim 1, further including the act of updating dynamic configuration information for said first host processor based upon the contents of said received message.

3. The method in claim 1, wherein said act of maintaining dynamic configuration information for said first host processor farther includes the act of associating each said transfer channel processor with a communication protocol specification selected from at least two communication protocol specifications; and wherein said act of forwarding further includes the act of conforming with the communication protocol specification associated with said destination transfer channel processor.

4. The method in claim 1, wherein said enterprise integration application system includes at least one terminal processor and the act of associating message keys with corresponding destination data depends upon conforming to a predetermined set of rules relating to the integration and operation of said at least one terminal processor into said enterprise integration application.

5. The method in claim 3, wherein said business rules include rules providing for the translation of data from one termination application into a format suitable for use for a second termination application.

6. The method in claim 1, wherein said messages include a unique primary message key; and wherein said message keys further includes identification of an origin host processor, an origin channel processor, origin processing indicia, a source host processor, a source channel processor, and source processing indicia.

7. The method in claim 6, wherein the method of forwarding messages includes the acts of:
determining destination data corresponding to said received message by reference to a message key of said received message;
preparing a forwarding message corresponding to said received message and said destination datum; and
sending each said forwarding message to said transfer channel processor corresponding to said destination datum host processor.

8. The method in claim 1, further including the act of determining whether said received message is a transfer message having an original message and an original message key; wherein said act of determining destination data corresponding to said received message includes the acts of:
determining destination data by reference to said primary key when said received message is not a transfer message; and
determining destination data by reference to said original message key when said received message is a transfer message; and wherein said act of preparing a forwarding message includes the acts of:
preparing a message substantially similar to said included message when said received message is a transfer message and said destination host processor is said first host processor;
preparing a transfer message including said received message when said received message is not a transfer message and said destination host processor is not said first host processor; and
preparing a message substantially similar to said received message when either said received message is not a transfer message and said destination host processor is said first host processor; or when said received message is a transfer message and said destination host processor is said first host processor.

9. The method in claim 1, wherein said act of maintaining dynamic configuration information for said first host processor further includes the act of associating each communicating channel processor with a communication protocol specification selected from a predetermined set of at least two communication protocol specifications; and wherein all acts of sending a message from a host processor to an communicating channel processor are performed in conformance with the communication protocol specification associated with said communicating channel processor.

10. A system for processing messages in an enterprise integration application system having at least three processors, comprising:
logic for the act of installing at least one host processor and at least one channel processor, each said channel processor in operative communication with two corresponding processors;
logic for the act of receiving at least one received message at a first host processor via a source channel processor, each received message having at least one corresponding message key, said message key including corresponding processing indicia;
logic for the act of maintaining dynamic configuration information for said first host processor, including:
logic for the act of associating each said host processor with corresponding communicating channel processors operatively communicating with said host processor;
logic for the act of associating each said host processor with corresponding transfer channel processors operatively communicating with said first host processor;
logic for the act of associating message keys with corresponding destination data, each said destination datum including a destination host processor and a destination channel processor;
logic for the act of forwarding messages corresponding to said received message from said first host processor to a destination transfer channel processor corresponding to a destination host processor determined by reference to said destination data corresponding to a message key of said received message;
whereby messages originating from a channel processor are dynamically routed through said enterprise integration application system in accordance with said association between message keys and destination data

11. The system in claim 10, further including logic for the act of updating dynamic configuration information for said first host processor based upon the contents of said received message.

12. The system in claim 10, wherein said logic for the act of maintaining dynamic configuration information for said first host processor further includes logic for associating each said transfer channel processor with a communication protocol specification selected from at least two communication protocol specifications; and wherein said logic for the act of forwarding further includes logic for conforming with the communication protocol specification associated with said destination transfer channel processor.

13. The system in claim 10, wherein said enterprise integration application system includes at least one terminal processor and said logic for the act of associating message keys with corresponding destination data depends upon conforming to a predetermined set of rules relating to the integration and operation of said at least one terminal processor into said enterprise integration application.

14. The system in claim 13, wherein said business rules include rules providing for the translation of data from one termination application into a format suitable for use for a second termination application.

15. The system in claim 10, wherein said messages include a unique primary message key; and wherein said message keys further includes identification of an origin host processor, an origin channel processor, origin processing indicia, a source host processor, a source channel processor, and source processing indicia.

16. The system in claim 15, wherein the logic for forwarding messages includes:
logic for the act of determining destination data corresponding to said received message by reference to a message key of said received message;
logic for the act of preparing a forwarding message corresponding to said received message and said destination datum; and
logic for the act of sending each said forwarding message to said transfer channel processor corresponding to said destination datum host processor.

17. The system in claim 10, further including logic for the act of determining whether said received message is a transfer message having an original message and an original message key; wherein said logic for the act of determining destination data corresponding to said received message includes:
logic for determining destination data by reference to said primary key when said received message is not a transfer message; and
logic for the act of determining destination data by reference to said original message key when said received message is a transfer message;
and wherein said logic for preparing a forwarding message includes:
logic for the act of preparing a message substantially similar to said included message when said received message is a transfer message and said destination host processor is said first host processor;
logic for the act of preparing a transfer message including said received message when said received message is not a transfer message and said destination host processor is not said first host processor; and
logic for the act of preparing a message substantially similar to said received message when either said received message is not a transfer message and said destination host processor is said first host processor; or when said received message is a transfer message and said destination host processor is said first host processor.

18. The system in claim 10, wherein said logic for the act of maintaining dynamic configuration information for said first host processor further includes logic for associating each communicating channel processor with a communication protocol specification selected from a predetermined set of at least two communication protocol specifications; and wherein all logic for the acts of sending a message from a host processor to an communicating channel processor specifies communication in conformance with the communication protocol specification associated with said communicating channel processor.

19. A computer program product for processing messages in an enterprise integration application system having at least three processors, comprising:
computer code for the act of installing at least one host processor and at least one channel processor, each said channel processor in operative communication with two corresponding processors;
computer code for the act of receiving at least one received message at a first host processor via a source channel processor, each received message having at least one corresponding message key, said message key including corresponding processing indicia;
computer code for the act of maintaining dynamic configuration information for said first host processor, including:
computer code for the act of associating each said host processor with corresponding communicating channel processors operatively communicating with said host processor;
computer code for the act of associating each said host processor with corresponding transfer channel processors operatively communicating with said first host processor;
computer code for the act of associating message keys with corresponding destination data, each said destination datum including a destination host processor and a destination channel processor;
computer code for the act of forwarding messages corresponding to said received message from said first host processor to a destination transfer channel processor corresponding to a destination host processor determined by reference to said destination data corresponding to a message key of said received message;
whereby messages originating from a channel processor are dynamically routed through said enterprise integration application system in accordance with said association between message keys and destination data

20. The system in claim 19, further including computer code for the act of updating dynamic configuration information for said first host processor based upon the contents of said received message.

21. The system in claim 19, wherein said computer code for the act of maintaining dynamic configuration information for said first host processor farther includes computer code for associating each said transfer channel processor with a communication protocol specification selected from at least two communication protocol specifications; and wherein said computer code for the act of forwarding further includes computer code for the act of conforming with the communication protocol specification associated with said destination transfer channel processor.

22. The system in claim 19, wherein said enterprise integration application system includes at least one terminal processor and said computer code for the act of associating message keys with corresponding destination data depends upon conforming to a predetermined set of rules relating to the integration and operation of said at least one terminal processor into said enterprise integration application.

23. The system in claim 22, wherein said business rules include rules providing for the translation of data from one termination application into a format suitable for use for a second termination application.

24. The system in claim 19, wherein said messages include a unique primary message key; and wherein said message keys further includes identification of an origin host processor, an origin channel processor, origin processing indicia, a source host processor, a source channel processor, and source processing indicia.

25. The system in claim 24, wherein the computer code for the act of forwarding messages includes:
computer code for the act of determining destination data corresponding to said received message by reference to a message key of said received message;
computer code for the act of preparing a forwarding message corresponding to said received message and said destination datum; and
computer code for the act of sending each said forwarding message to said transfer channel processor corresponding to said destination datum host processor.

26. The system in claim 19, further including computer code for the act of determining whether said received message is a transfer message having an original message and an original message key; wherein said computer code for determining destination data corresponding to said received message includes:
computer code for the act of determining destination data by reference to said primary key when said received message is not a transfer message; and
a computer code for the act of determining destination data by reference to said original message key when said received message is a transfer message;
and wherein said computer code for preparing a forwarding message includes:
computer code for the act of preparing a message substantially similar to said included message when said received message is a transfer message and said destination host processor is said first host processor;
computer code for the act of preparing a transfer message including said received message when said received message is not a transfer message and said destination host processor is not said first host processor; and
computer code for the act of preparing a message substantially similar to said received message when either said received message is not a transfer message and said destination host processor is said first host processor; or when said received message is a transfer message and said destination host processor is said first host processor.

27. The system in claim 19, wherein said computer code for the act of maintaining dynamic configuration information for said first host processor further includes computer code for the act of associating each communicating channel processor with a communication protocol specification selected from a predetermined set of at least two communication protocol specifications; and wherein all computer code for the act of sending a message from a host processor to an communicating channel processor specifies communication in conformance with the communication protocol specification associated with said communicating channel processor.
